(19) United States
(12) Patent Application Publication
(10) Pub. No.: US 2022/0277712 A1
(43) Pub. Date: Sep. 1, 2022

(54) Musical Instrument Shield for Playing Wind Blown Instruments

(71) Applicant: Pamela Yee Shuck, Oakland, MI (US)

(72) Inventor: Pamela Yee Shuck, Oakland, MI (US)

(21) Appl. No.: 17/510,384

(22) Filed: Oct. 26, 2021

Related U.S. Application Data
(60) Provisional application No. 63/083,867, filed on Sep. 26, 2020.

(51) Int. Cl. G10D 9/00

(52) U.S. Cl. CPC G10D 9/00

(57) ABSTRACT

The musical instrument shield invention is a clear or translucent enclosure made of flexible plastic material that aids to contain droplets from spreading while still providing full view of the instrument. Access ports for the musicians' hands, fingers, clip rings, and thumb rests are cut in the plastic and reinforced as needed to prevent tearing. The musical instrument shield is attached to the neck of the instrument with ties, string, elastic, laces, Velcro or other suitable material to hold the proximal end of the shield around the instrument. The woodwind shield can incorporate one or more filtered vents that prevent pressure from building up during playing yet still resist any infectious droplets from passing out of the shield. The access ports are closed when not in use and direct any aerosols that may escape through the ports while in use down toward the ground. The clear shield allows teachers and others to see the instrument and musician's fingering while still providing unencumbered playing and clear producing sound. The see through shield can be made of any non-porous material that can effectively block transmission of infectious droplets or air borne viruses. A hybrid shield made of both clear and opaque materials would allow for the instrument to be visualized as well as vented to prevent pressure build-up within the shield.

Other objects and advantages of the invention will become apparent from the following claims and detailed description of the invention taken in conjunction with the accompanying drawings.

### CROSS-REFERENCE TO RELATED APPLICATIONS

This application claims priority to U.S. Provisional Patent Application No. 63/083,867 filed Sep. 26, 2020.

### BACKGROUND OF THE INVENTION

The present invention relates to musical instrument shields for the protection of infection spreading through musicians' droplets and aerosols as they blow through their brass and woodwind instruments. Infection protection shields have mostly been used as face shields in the medical community to protect the healthcare worker from direct sneezes, coughs, or other patient produced sprays. In the era of the Covid-19 pandemic, plastic face shields have also been used by the general public to protect both the wearer and others around them. Most live music venues have been shut down during the Covid-19 pandemic not only because it is difficult for the audience to physically distance, but also because musicians are not able to easily control potentially infected droplets that are exhaled through normal breathing and through their instruments.

With the introduction of Covid-19 and anticipation of other future novel coronaviruses for which there are not vaccines, the CDC recommends the best way to prevent infection spread when out in public is the wearing of face coverings such as cloth masks, handwashing, and to physically distance at least six feet apart from others. Musicians who play instruments such as woodwinds or brass can play through improvised masks but the air coming from the instrument is not captured by the mask. Viruses, including the Covid-19 are largely thought to be transmitted from human-to-human by droplets, aerosols, and fomites.

Musical instrument bags that claim to protect spread of droplets that disperse through the instrument keys are made of porous, opaque fabric that do not adequately filter the aerosols nor do they allow the unencumbered visualization of the musicians' fingering.

Musicians in school bands, community bands, and professional bands run the risk of spreading viruses when potentially infected members play instruments such as woodwinds without protecting all key holes and other openings where air or droplets escape the instrument. It is also difficult to maintain six feet of distance (or greater when pertaining to the more transmissible viruses such as the Delta virus) between members of large bands on a stage due to the large size of the stage needed.

The physical (social) distancing guideline of six feet away (or greater) from others allows any larger droplets time to drop to the ground or be diluted before reaching others. Physical distancing does not prevent spread 100% of the time as factors such as wind, fans, and HVAC could potentially keep micro droplets airborne for longer distances and times.

### BRIEF DESCRIPTION OF THE SEVERAL VIEWS OF THE DRAWING

FIGS. 1 and 2 are illustrations of my musical instrument shields showing a top cuff (1) that is tightened around the neck (2) of sample instruments. The cuff could be formed by ties (3), straps, elastic, Velcro, or any other material that still allows for adjustability to different instrument neck sizes. Two hand access ports with sealing protective flaps (4) accommodate just fingers or entire hands depending on the musicians' preference. The distal end of the shield can be sealed shut (5) or can provide a location for a filtered vent (6) which serves to minimize the transmission of viruses or droplets but still allows air and sound to penetrate.

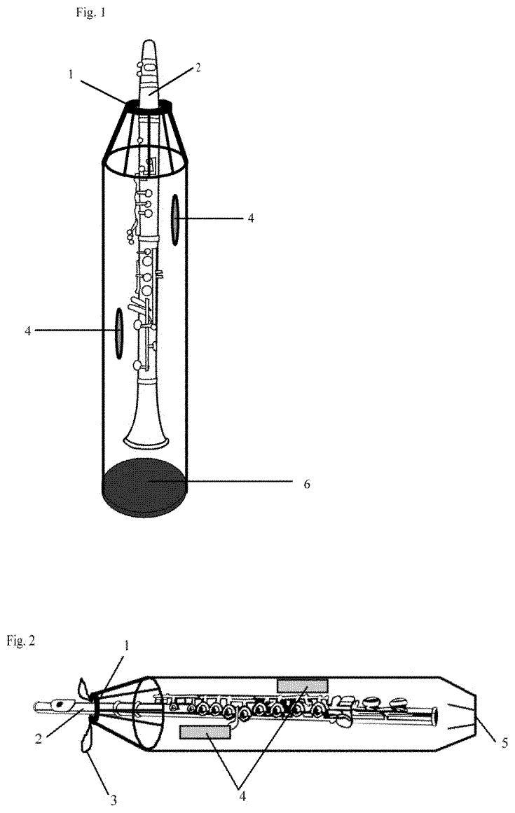

FIG. 3 is a back view of my musical instrument shield showing a reinforced slot (7) which would fit instrument supports such as a saxophone clip ring.

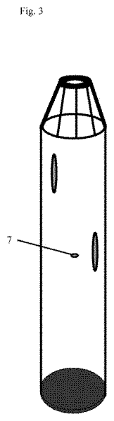

### DETAILED DESCRIPTION OF THE INVENTION

The present invention relates to a musical instrument shield that is used to slow the rate of disease transmission caused by infectious droplets or aerosols while playing the instruments.

In one aspect of the present invention, the shield includes a thin clear or translucent plastic film that encircles the instrument and extends from the neck of the instrument to below the end of the instrument.

In another aspect of the present invention, the proximal end of the plastic film is attached to the neck of the instrument with string, ties, fabric, straps, elastic, belts, or any other suitable material that can accommodate various plastic flexibility and different circumferences of instrument necks.

In another aspect of the present invention, the distal end of the plastic sheet can be closed off around the distal tip of the instrument with foam, fabric, or other suitable droplet filtering materials designed to resist the escape of virus laden droplets.

In another aspect of the present invention, the hand ports are closed when not in use.

In another aspect of the present invention, the hand ports open wide enough to insert a full hand but then collapse back down to block droplets from escaping through the hand ports when in use.

In another aspect of the present invention, the hand ports direct any air or aerosol escaping from the ports downward to the ground or back toward the musician player where others in close proximity are less likely to inhale it.

In another aspect of the present invention, the edges of the hand access ports are smooth or have an edge protection so they don't irritate the musician's skin.

In another aspect of the present invention, the musical instrument is inserted into the bag shield and then the proximal end is closed to confine any droplets.

In another aspect of the present invention, the clear plastic sheet can be made with antifog coating to prevent fogging when blowing high humidity breaths into the instrument for extended periods of time.

In another aspect of the present invention, the musical instrument shield can be made in different sizes to accommodate all sizes from piccolos to contrabassoons.

It is an object of the invention to provide a musical instrument shield to protect all people in the vicinity of the musician from exposure to infectious droplets that arise via the playing of musical instruments.

It is a further object of the invention to provide a low-cost, cleanable, multi-use, single user instrument shield

Another object of the invention is to direct airflow from instruments that contains potentially infectious viruses down toward the ground or back toward the player where they are less likely to come into contact with surrounding people. This in effect achieves the same goal that physical distancing does but without relying solely on gravity to achieve.

Yet another object of the invention is to allow traditionally high risk activities that involve deep breathing, aerosol generating instrument playing to a more confined space within the sealed instrument shield.

Still another object of the invention is to allow enough filtered air to leave the sealed instrument shield to prevent any significant pressure build up within the sealed instrument shield.

Another object of the invention is to provide full instrument viewing by teachers or surrounding people.

### RELEVANT PRIOR ART

| | | |
|---|---|---|
| 6,774,296 | August 2004 | Aesch |
| 6,774,296 | May 2001 | Robinson |
| 4,000,678 | January 1977 | Messina |
| 4,121,494 | October 1978 | Reno |
| 5,875,890 | March 1999 | DiBernardini |
| U.S. Pat. No. 9,183,816B2 | November 2015 | Brawley |
| 9,251,772 | February 2016 | Hungate |

Current US Class: 84/382

1. A clear musical instrument shield that is used to slow the rate of disease transmission caused by infectious droplets or aerosols escaping the instrument while playing.

2. Said shield of claim 1 encloses musical instruments that have key holes or other orifices that allow air to escape from the instrument.

3. Said shield of claim 1 is cinched at the proximal end around the neck of the instrument with string, ties, fabric, straps, elastic, belts, or any other suitable material that can accommodate various shield flexibility and different circumferences of instrument necks.

4. The clear material of claim 1 allows direct visualization of the instrument and musician's fingering.

5. The clear material of claim 1 is impermeable to droplet or aerosol penetration.

6. The shield of claim 1 has hand ports which open wide enough to insert a full hand but then collapse back down to block droplets from escaping through the hand ports during use.

7. The hand ports of claim 6 allow the user access to their instrument inside the shield but collapse back down when not in use.

8. The hand ports of claim 6 direct any air or aerosol escaping from the ports downward to the ground or back toward the musician player where others in close proximity are not likely to inhale it.

9. The hand ports of claim 6 have edge protection to reinforce the hand ports and protect the musician's skin from irritation.

10. If needed, one or more filtering vents designed to release any pressure build-up within the shield while resisting the escape of virus laden droplets and aerosols can be incorporated into said shield of claim 1.

11. The vent(s) of claim 10 are not needed for instruments that release low volumes of air.

12. Air is vented through the hand ports of claim 6 and filtered vent(s) of claim 10 that allow positive pressure to be relieved for instruments that release high volumes of air.

13. The clear or translucent part of said instrument shield in claim 1 is made of flexible material which may include, but is not limited to material such as plastic which is impermeable to disease laden droplets, lightweight, durable, cleanable, and inexpensive to produce, although other materials may be suitable.

14. The clear or translucent impermeable material of claim 13 is light weight so as to not depress or block any instrument keys or interfere with the musician's instrument playing.

15. The clear or translucent impermeable material of claim 13 can be made with thin, inexpensive plastic that is strong enough to withstand many uses and simple to wipe down to keep clean.

16. The clear or translucent impermeable material of claim 13 effectively blocks airborne viruses and respiratory droplets from passing through it.

17. The filter materials of claim 10 and the clear or translucent impermeable material of claim 13 used in said instrument shield in claim 1 maintains the tonal quality of the instrument and does not perceptibly dampen or muffle the sound while playing.

18. The materials of claim 17 allow sound waves to travel through them while still blocking viruses, aerosol, and droplets from penetrating through them.
